(19) United States
(12) Patent Application Publication
(10) Pub. No.: US 2025/0105989 A1
(43) Pub. Date: Mar. 27, 2025

(54) TERMINAL AND WIRELESS COMMUNICATION METHOD

(71) Applicant: NTT DOCOMO, INC., Tokyo (JP)

(72) Inventors: Yuki Takahashi, Tokyo (JP); Satoshi Nagata, Tokyo (JP); Qiping Pi, Beijing (CN); Jing Wang, Beijing (CN); Lan chen, Beijing (CN)

(73) Assignee: NTT DOCOMO, INC., Tokyo (JP)

(21) Appl. No.: 18/291,459

(22) PCT Filed: Jul. 26, 2021
(86) PCT No.: PCT/JP2021/027612

§ 371 Date: Jan. 23, 2024

(51) Int. Cl. H04L 5/00; H04W 72/21

(52) U.S. Cl. CPC H04L 5/0098; H04W 72/21

(57) ABSTRACT

This terminal comprises a control unit that determines a cell to transmit control information on the basis of a timing pattern indicating the order of cells to transmit the control information, and a transmitting unit that transmits the control information in the determined cell. If the timing pattern includes Scell to be de-activated, the timing pattern is changed before Scell is de-activated.

### TECHNICAL FIELD

The present disclosure relates to a terminal and a radio communication method.

### BACKGROUND ART

Long Term Evolution (LTE) has been specified for achieving a higher data rate, lower delay, and the like in a Universal Mobile Telecommunication System (UMTS) network. Future systems of LTE have also been studied for achieving a broader bandwidth and a higher speed based on LTE. Examples of the future systems of LTE include systems called LTE-Advanced (LTE-A), Future Radio Access (FRA), 5th generation mobile communication system (5G), 5G plus (5G+), Radio Access Technology (New-RAT), New Radio (NR), and the like.

In NR, for example, enhancement of a feedback function from a terminal to a base station has been discussed in order to improve the communication quality (e.g., see Non-Patent Literature (hereinafter, referred to as “NPL”) 1).

Information to be fed back from the terminal to the base station is transmitted in a resource of a Physical Uplink Control Channel (PUCCH). Supporting PUCCH carrier switching has been agreed with respect to the extension of an Ultra-Reliable and Low Latency Communications (URLLC) technology in Release 17 of 3GPP.

Semi-static PUCCH carrier switching is performed based on a timing pattern of a cell for transmitting PUCCH. It has been discussed that the terminal determines, based on the pattern, a cell used for transmitting information to be fed back from the terminal to the base station.

### CITATION LIST

### Non-Patent Literature

NPL 1
“Enhanced Industrial Internet of Things (IoT) and ultra-reliable and low latency communication,” RP-201310, 3GPP TSG RAN Meeting #86e, 3GPP, July 2020

### SUMMARY OF INVENTION

### Technical Problem

There is scope for further study on determination of a cell used for transmitting information to be fed back from a terminal to a base station.

An aspect of the present disclosure is to provide a terminal and a radio communication method each capable of appropriately determing a cell used for transmitting information to be fed back from a terminal to a base station.

A terminal according to an aspect of the present disclosure includes: a control section that determines a cell for transmitting control information, based on a timing pattern indicating an order of a plurality of the cells for transmitting the control information; and a transmission section that transmits the control information in the determined cell, in which, when the timing pattern includes an Scell to be de-activated, the timing pattern is changed before the Scell is de-activated.

A radio communication method according to an aspect of the present disclosure includes: determining, by a terminal, a cell for transmitting control information, based on a timing pattern indicating an order of a plurality of the cells for transmitting the control information; and transmitting, by the terminal, the control information in the determined cell, in which, when the timing pattern includes an Scell to be de-activated, the timing pattern is changed.

### BRIEF DESCRIPTION OF DRAWINGS

FIG. 1 illustrates an example of dual connectivity (DC);

FIG. 2 illustrates an example of PUCCH carrier switching;

FIG. 3 illustrates an example of PUCCH cell determination based on a PUCCH-cell timing pattern;

FIG. 4 is a block diagram illustrating an exemplary configuration of a base station according to an embodiment;

FIG. 5 is a block diagram illustrating an exemplary configuration of a terminal according to the present embodiment;

FIG. 6 illustrates an example of PUCCH cell determination in Opt 2-1;

FIG. 7 illustrates an example of PUCCH cell determination in Opt 2-2A;

FIG. 8 illustrates an example of PUCCH cell determination in Opt 2-2B;

FIG. 9 illustrates an example of PUCCH cell determination in Opt 2-3A;

FIG. 10 illustrates an example of PUCCH cell determination in Opt 2-3B; and

FIG. 11 illustrates an exemplary hardware configuration of the base station and the terminal according to the present embodiment.

### DESCRIPTION OF EMBODIMENTS

### Findings Leading to the Present Disclosure

3GPP has been discussing technologies for schemes called Ultra-Reliable and Low Latency Communications (URLLC) and Industrial Internet of Things (IIoT) in Rel. 17.

In URLLC, enhancement of a feedback function of a terminal for a Hybrid Automatic Repeat request-Acknowledgement (HARQ-ACK) has been studied. The HARQ-ACK is an example of information on a confirmation response (e.g., acknowledgement) to data received by the terminal. With respect to these study matters for URLLC, supporting dynamic and semi-static PUCCH carrier switching has been agreed. Note that, the PUCCH carrier switching may be called by other names such as control-information-transmitting carrier switching.

The PUCCH carrier switching is a technology to be applied to a case where a base station performs communication through a plurality of cells. Hereinafter, dual connectivity, which is an example of the communication through a plurality of cells, and the PUCCH carrier switching will be described.

### Dual Connectivity

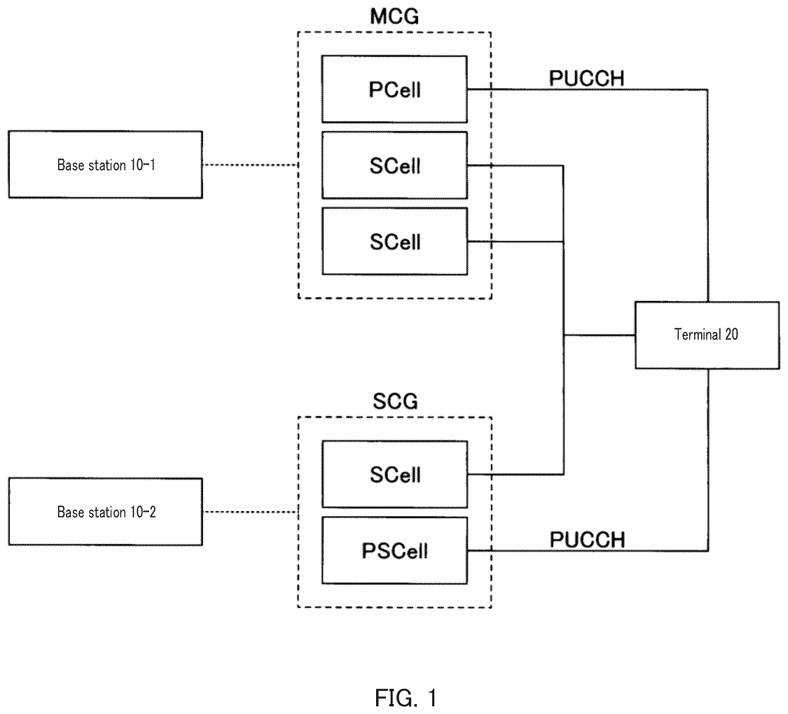

FIG. 1 illustrates an example of dual connectivity (DC). In the example of FIG. 1, base station 10-1 may be a Master Node (MN), and base station 10-2 may be a Secondary Node (SN). As illustrated in the example of FIG. 1, carriers between different base stations are aggregated in the DC.

In the example of FIG. 1, base station 10-1 communicates with terminal 20 through a primary cell (Pcell) and secondary cells (Scells). In the example of FIG. 1, terminal 20 has established an RRC connection with base station 10-1.

In the case of DC, a delay in communication between base stations 10-1 and 10-2 may be present, so that it is difficult to indicate, to base station 10-2, uplink control information (e.g., UCI) received in the Pcell of base station 10-1 via a backhaul link (e.g., a wired or wireless link connecting between base stations 10-1 and 10-2) to reflect the uplink control information in scheduling of an Scell under base station 10-2. Accordingly, in the DC, in addition to the Pcell of base station 10-1, one carrier under base station 10-2 may be configured as a Primary Scell (PScell), and PUCCH transmission may be supported by the PScell. In this case, terminal 20 transmits the UCI to base station 10-2 through the PScell.

In the example of FIG. 1, terminal 20 configures, in addition to the Pcell, the Scells for base station 10-1. Further, terminal 20 configures, in addition to the PScell, the Scell for base station 10-2. Terminal 20 transmits the UCI of each carrier under base station 10-1 via PUCCH of the Pcell. Further, terminal 20 transmits the UCI of each carrier under base station 10-2 via PUCCH of the PScell. In the example of FIG. 1, a cell group (CG) under base station 10-1 may be referred to as a Master Cell-Group (MCG), and a cell group under base station 10-2 may be referred to as a Secondary Cell-Group (SCG).

In a case where the DC is performed, terminal 20 transmits PUCCH through a Pcell, a PScell, and/or a PUCCH-Scell. Generally, it is not assumed that terminal 20 transmits PUCCH through an Scell other than the Pcell, the PScell, and the PUCCH-Scell.

The PUCCH carrier switching has been studied as a method of reducing latency in HARQ-ACK feedback in a Time Division Duplex (TDD) scheme.

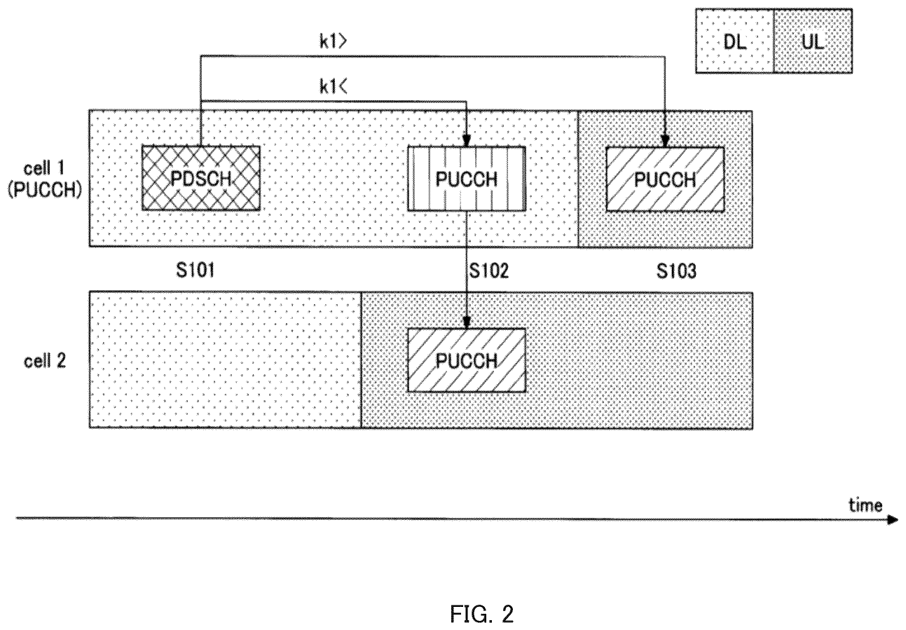

FIG. 2 illustrates an example of the PUCCH carrier switching.

In the example of FIG. 2, base station 10 and terminal 20 communicate with each other through cells 1 and 2. In the example of FIG. 2, cell 1 is a Pcell whereas cell 2 is an Scell. Further, the example of FIG. 2 illustrates downlink (DL) slots and uplink (UL) slots in the cells.

In the example of FIG. 2, terminal 20 receives data (receives PDSCH) at the timing of S101. Terminal 20 attempts to transmit HARQ-ACK for the data received in S101 at the timing of S102, but the slot of cell 1 at the timing of $102 is the downlink (DL) slot. For this reason, in a case where terminal 20 transmits HARQ-ACK in cell 1, transmission of the HARQ-ACK is held until a transmission timing of PUCCH in the uplink (UL) slot (e.g., timing of S103 of FIG. 2), so that latency in the HARQ-ACK transmission increases. Note that, the PUCCH transmission timing in the uplink (UL) slot may be referred to as a PUCCH transmission occasion.

In the example of FIG. 2, the slot of cell 2 at the timing of S102 is the UL slot. In the example of FIG. 2, the latency in the HARQ-ACK transmission can be reduced when terminal 20 can transmit the HARQ-ACK for the data received in S101 on the PUCCH transmission occasion at the timing of S102 in cell 2. In URLLC, low delay in a radio section is especially required. Accordingly, in 3GPP, the PUCCH carrier switching in which terminal 20 switches between carriers for performing PUCCH transmission has been studied as an extension of the URLLC technology.

Note that, in the following embodiment, “the same timing” may be completely the same timing or may represent that all or some of time resources (e.g., one or a plurality of symbols (which may also be resource(s) in time units shorter than symbols)) are the same or overlap.

The PUCCH carrier switching may represent that in a case where terminal 20 attempts to perform PUCCH transmission at a specific transmission timing of a Pcell (which may be PScell or PUCCH-Scell), terminal 20 switches a cell in which the PUCCH transmission is performed from the Pcell (which may be PScell or PUCCH-Scell) to an Scell (which is Scell other than PScell in the case of PScell and is Scell other than PUCCH-Scell in the case of PUCCH-Scell) of one or a plurality of Scells in which a slot at the same timing as the specific transmission timing is a UL slot, since the slot at the specific transmission timing of the Pcell (which may be PScell or PUCCH-Scell) is a DL slot. Note that, in an embodiment of the present invention, the unit of the specific transmission timing is not limited to the slot. For example, the specific transmission timing may be a timing in units of subframes or may be a timing in units of symbols.

Two methods have been studied for achieving the PUCCH carrier switching. The first method is a method in which base station 10 dynamically indicates, to terminal 20, a carrier for performing PUCCH transmission. The second method is a method in which base station 10 semi-statically configures, for terminal 20, a carrier for performing the PUCCH transmission. Note that, in the embodiment described below, “PUCCH transmission” and “transmitting PUCCH” may refer to transmission of uplink control information via PUCCH.

Terminal 20 may indicate, to base station 10, terminal capability information (UE capability) that specifies information on capability of the terminal for the PUCCH transmission. For example, information indicating whether terminal 20 supports switching between configurations related to transmission of control information may be specified as the UE capability information of terminal 20. The switching between configurations related to transmission of control information may be, for example, switching between resources (e.g., carriers) used for transmitting the control information. The switching between resources used for transmitting the control information may also be referred to as “PUCCH carrier switching.”

As the UE capability information of terminal 20, information indicating whether terminal 20 supports PUCCH carrier switching that is based on a DCI associated with PUCCH may be specified.

As the UE capability information of terminal 20, information indicating whether terminal 20 supports PUCCH carrier switching that is based on a DCI not associated with PUCCH may be specified.

For example, for the PUCCH carrier switching, it has been agreed that a PUCCH resource may be configured per Uplink Bandwidth Part (UL BWP) (e.g., per candidate cell and per UL BWP of candidate cell).

An operation for the semi-static PUCCH carrier switching is based on a PUCCH-cell timing pattern (hereinafter sometimes simply referred to as “pattern”) and supports PUCCH carrier switching between cells having different neurologies. Incidentally, the PUCCH-cell timing pattern is a pattern that indicates the order of cells that transmit PUCCH (control information).

In the semi-static PUCCH carrier switching, however, de-activation of an Scell included in a PUCCH-cell timing pattern has so far not been considered.

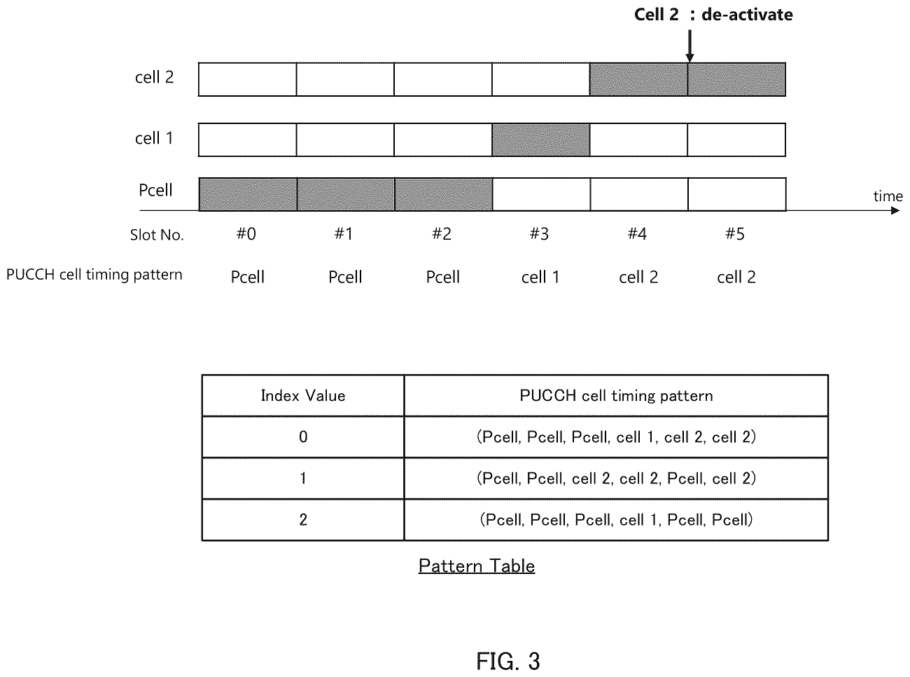

A problem of the semi-static PUCCH carrier switching based on the PUCCH-cell timing pattern will be described with reference to FIG. 3. In the example of FIG. 3, it is assumed that a Pcell and two Scells (cell 1 and cell 2) are cells that support PUCCH transmission, i.e., cells that may transmit PUCCH (hereinafter referred to as “candidate PUCCH cells”).

Note that a plurality of PUCCH-cell timing patterns is configured in advance, and base station 10 and terminal 20 each have a pattern table that indicates a relationship between the plurality of PUCCH-cell timing patterns and indices associated recpetively with the patterns.

During the PUCCH carrier switching, only one of the plurality of PUCCH-cell timing patterns is enabled. The enabled PUCCH-cell timing pattern is indicated from base station 10 to terminal 20 by an index via Radio Resource Control (RRC).

In the example of FIG. 3, the enabled PUCCH-cell timing pattern is (Pcell, Pcell, Pcell, cell 1, cell 2, cell 2) with the index value “0”.

Terminal 20 determines a PUCCH cell in accordance with the enabled pattern. In FIG. 3, PUCCH resources are colored in gray. Although not illustrated in FIG. 3, terminal 20 repeatedly uses the indicated pattern and determines, even in slot #6 and subsequent slots, a PUCCH cell in accordance with the enabled pattern (Pcell, Pcell, Pcell, cell 1, cell 2, cell 2).

Consequently, terminal 20 transmits the UCI through the Pcell in slots #0, #1, and #2, transmits the UCI through cell 1 in slot #3, and transmits the UCI through cell 2 in slots #4 and #5.

However, in a situation where cell 2 is determined to be de-activated from slot #5, base station 10 cannot receive the UCI in slot #5 even when terminal 20 transmits the UCI in accordance with the pattern (Pcell, Pcell, Pcell, cell 1, cell 2, cell 2).

Thus, in the semi-static PUCCH carrier switching operation, there is scope for further study on determination of a cell used for transmitting information to be fed back from a terminal to a base station.

Hereinafter, on the basis of the above-mentioned study matters, provided are a terminal and a radio communication method each capable of appropriately determing a cell used for transmitting the information even when an Scell is de-activated.

### Example of Radio Communication System

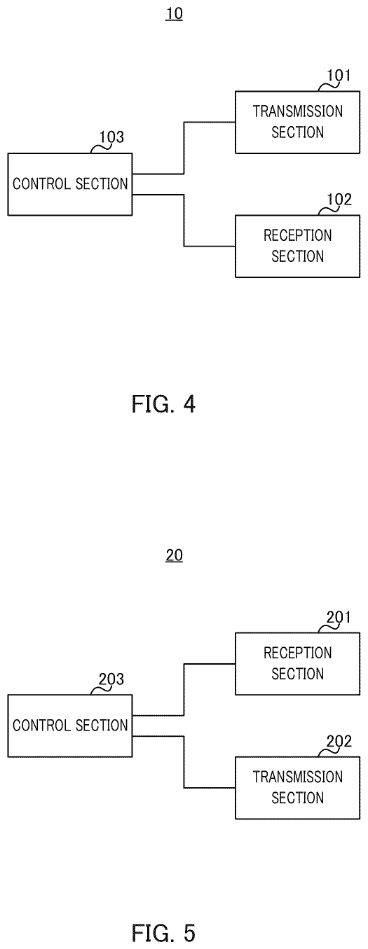

A radio communication system according to the present embodiment includes base station 10 illustrated in FIG. 4 and terminal 20 illustrated in FIG. 5. The number of base stations 10 and the number of terminals 20 are not particularly limited. For example, the system may be as illustrated in FIG. 1 in which two base stations 10 (base stations 10-1 and 10-2) communicate with one terminal 20. The radio communication system may be a radio communication system conforming to New Radio (NR). Illustratively, the radio communication system may be a radio communication system conforming to a scheme called URLLC and/or IIoT.

Note that, the radio communication system may be a radio communication system conforming to a scheme called 5G, Beyond 5G, 5G Evolution or 6G.

Base station 10 may be referred to as an NG-RAN Node, an ng-eNB, an eNodeB (eNB), or a gNodeB (gNB). Terminal 20 may be referred to as User Equipment (UE). Further, base station 10 may be regarded as an apparatus included in a network to which terminal 20 is connected.

The radio communication system may include a Next Generation-Radio Access Network (hereinafter referred to as NG-RAN). The NG-RAN includes a plurality of NG-RAN Nodes, specifically a plurality of gNBs (or ng-eNBs), and is connected to a core network (5GC, not illustrated) conforming to 5G. Note that, the NG-RAN and the 5GC may be simply represented as “network.”

Base station 10 performs radio communication with terminal 20. For example, the radio communication to be performed conforms to the NR. By controlling radio signals transmitted from a plurality of antenna elements, at least one of base station 10 and terminal 20 may support Massive Multiple-Input Multiple-Output (MIMO) that generates a beam (BM) having higher directivity. Further, at least one of base station 10 and terminal 20 may support carrier aggregation (CA) that aggregates and uses a plurality of component carriers (CC). Further, at least one of base station 10 and terminal 20 may support, e.g., dual connectivity (DC) in which communication is performed between terminal 20 and each of a plurality of base stations 10.

The radio communication system may support a plurality of frequency bands. For example, the radio communication system supports Frequency Range (FR) 1 and FR 2. For example, the frequency bands of the respective FRs are as follows:
FR 1: 410 MHz to 7.125 GHz; and
FR 2: 24.25 GHz to 52.6 GHz.

In FR. 1, a Sub-Carrier Spacing (SCS) of 15 kHz, 30 kHz or 60 kHz may be used, and a bandwidth (BW) of 5 MHz to 100 MHz may be used. FR 2 is, for example, a higher frequency than FR 1. In FR 2, an SCS of 60 KHz or 120 kHz may be used and a bandwidth (BW) of 50 MHz to 400 MHz may be used. FR 2 may also include an SCS of 240 KHz.

The radio communication system in the present embodiment may support a higher frequency band than the frequency band of FR 2. For example, the radio communication system in the present embodiment may support a frequency band exceeding 52.6 GHz and up to 114.25 GHz. Such a high frequency band may be referred to as “FR 2x.”

Further, Cyclic Prefix-Orthogonal Frequency Division Multiplexing (CP-OFDM)/Discrete Fourier Transform-Spread-Orthogonal Frequency Division Multiplexing (DFT-S-OFDM) having a sub-carrier spacing (SCS) larger than that in the examples described above may be applied. Further, the DFT-S-OFDM may be applied to either one or both of uplink and downlink.

In the radio communication system, a slot configuration pattern of Time Division Duplex (TDD) may be configured. For example, a pattern representing the order of two or more slots among a slot for transmitting a downlink (DL) signal, a slot for transmitting an uplink (UL) signal, a slot in which a DL signal(s), a UL signal(s), and a guard symbol(s) are mixed, and a slot in which a signal to be transmitted is flexibly changed may be specified in the slot configuration pattern.

Further, in the radio communication system, it is possible to perform PUSCH (or Physical Uplink Control Channel (PUCCH)) channel estimation by using a demodulation reference signal (DMRS) per slot, but it is further allowed to perform PUSCH (or PUCCH) channel estimation by using DMRSs assigned to a plurality of slots, respectively. Such channel estimation may be referred to as joint channel estimation or may be referred to as another name, such as cross-slot channel estimation.

In a plurality of slots, terminal 20 may transmit DMRSs assigned to the plurality of slots, respectively, such that base station 10 can perform the joint channel estimation using DMRSs.

Further, in the radio communication system, an enhanced function may be added to the function of feedback from terminal 20 to base station 10. For example, an enhanced feedback function of the terminal for HARQ-ACK may be added.

Next, configurations of base station 10 and terminal 20 will be described. Note that the configurations of base station 10 and terminal 20 described below illustrate an example of functions related to the present embodiment. Base station 10 and terminal 20 may have functions that are not illustrated. Further, functional classification and/or names of functional sections are/is not limited as long as the functions serve for executing operations according to the present embodiment.

### Configuration of Base Station

FIG. 4 is a block diagram illustrating an exemplary configuration of base station 10 according to the present embodiment. Base station 10 includes, for example, transmission section 101, reception section 102, and control section 103. Base station 10 communicates wirelessly with terminal 20 (see FIG. 5).

Transmission section 101 transmits a downlink (DL) signal to terminal 20. For example, transmission section 101 transmits the DL signal under the control of control section 103.

The DL signal may include, for example, a downlink data signal and control information (e.g., Downlink Control Information (DCI)). The DL signal may also include information (e.g., UL grant) indicating scheduling related to signal transmission of terminal 20. Moreover, the DL signal may include higher layer control information (e.g., Radio Resource Control (RRC) control information). Furthermore, the DL signal may include a reference signal.

Channels used for DL signal transmission include, for example, a data channel and a control channel For example, the data channel may include a Physical Downlink Shared Channel (PDSCH), and the control channel may include a Physical Downlink Control Channel (PDCCH). For example, base station 10 transmits control information to terminal 20 by using PDCCH and transmits a downlink data signal by using PDSCH.

The reference signal included in the DL signal may include, for example, at least one of a Demodulation Reference Signal (DMRS), a Phase Tracking Reference Signal (PTRS), a Channel State Information-Reference Signal (CSI-RS), a Sounding Reference Signal (SRS), and a Positioning Reference Signal (PRS) for position information. For example, the reference signal such as the DMRS and the PTRS is used for demodulation of a downlink data signal and is transmitted by using PDSCH.

Reception section 102 receives an uplink (UL) signal transmitted from terminal 20. For example, reception section 102 receives the UL signal under the control of control section 103.

Control section 103 controls communication operations of base station 10 including transmission processing in transmission section 101 and reception processing in reception section 102.

By way of example, control section 103 acquires information such as data and control information from a higher layer and outputs the data and control information to transmission section 101. Further, control section 103 outputs the data, the control information, and/or the like received from reception section 102 to the higher layer.

For example, control section 103 allocates a resource (or channel) used for DL signal transmission and reception and/or a resource used for UL signal transmission and reception, based on the signal (e.g., data, control information and/or the like) received from terminal 20 and/or the data, the control information, and/or the like acquired from the higher layer. Information on the allocated resource(s) may be included in control information to be transmitted to terminal 20.

Control section 103 configures a PUCCH resource as an example of the allocation of the resource used for UL transmission and reception. Information on the PUCCH configuration such as a PUCCH cell timing pattern (PUCCH configuration information) may be indicated to terminal 20 by RRC.

### Configuration of Terminal

FIG. 5 is a block diagram illustrating an exemplary configuration of terminal 20 according to the present embodiment. Terminal 20 includes, for example, reception section 201, transmission section 202, and control section 203. Terminal 20 communicates wirelessly with, for example, base station 10.

Reception section 201 receives a DL signal transmitted from base station 10. For example, reception section 201 receives the DL signal under the control of control section 203.

Transmission section 202 transmits an UL signal to base station 10. For example, transmission section 202 transmits the UL signal under the control of control section 203.

The UL signal may include, for example, an uplink data signal and control information (e.g., UCI). For example, information on processing capability of terminal 20 (e.g., UE capability) may also be included. Further, the UL signal may include a reference signal.

Channels used for UL signal transmission include, for example, a data channel and a control channel. For example, the data channel includes a Physical Uplink Shared Channel (PUSCH) and the control channel includes a Physical Uplink Control Channel (PUCCH). For example, terminal 20 receives control information from base station 10 by using PUCCH and transmits an uplink data signal by using PUSCH.

The reference signal included in the UL signal may include, for example, at least one of a DMRS, a PTRS, a CSI-RS, an SRS, and a PRS. For example, the reference signal such as the DMRS and the PTRS is used for demodulation of an uplink data signal and is transmitted by using an uplink channel (e.g., PUSCH).

Control section 203 controls communication operations of terminal 20 including reception processing in reception section 201 and transmission processing in transmission section 202.

By way of example, control section 203 acquires information such as data and control information from a higher layer and outputs the data and control information to transmission section 202. Further, control section 203 outputs, for example, the data, the control information, and/or the like received from reception section 201 to the higher layer.

For example, control section 203 controls transmission of information to be fed back to base station 10. The information to be fed back to base station 10 may include, for example, HARQ-ACK, Channel State Information (CSI), and a Scheduling Request (SR.). The information to be fed back to base station 10 may be included in the UCI. The UCI is transmitted in a PUCCH resource.

Control section 203 configures a PUCCH resource based on the configuration information (e.g., configuration information such as PUCCH cell timing pattern and/or DCI, which are/is indicated by RRC) received from base station 10. Control section 203 determines the PUCCH resource to be used for transmitting the information to be fed back to base station 10. Under the control of control section 203, transmission section 202 transmits the information to be fed back to base station 10 in the PUCCH resource determined by control section 203.

Note that, the channels used for DL signal transmission and the channels used for UL signal transmission are not limited to the examples mentioned above. For example, the channels used for the DL signal transmission and the channels used for the UL signal transmission may include a Random Access Channel (RACH) and a Physical Broadcast Channel (PBCH). The RACH may be used for, for example, transmission of Downlink Control Information (DCI) including a Random Access Radio Network Temporary Identifier (RA-RNTI).

### PUCCH Cell Determination

Next, determination of a PUCCH cell when an Scell is de-activated will be described.

### Option 1

In Option 1, base station 10 executes control to update a PUCCH-cell timing pattern before an Scell is de-activated. In Option 1, terminal 20 need not execute control to assume an Scell to be de-activated in a PUCCH-cell timing pattern.

In the following, variations of Option 1 (Opt 1) and the details of each variation will be specifically described.

[Opt 1-1]: The semi-static PUCCH-cell timing pattern is reconfigured by RRC.

In this case, prior to the start of PUCCH-cell timing pattern used at the timing of de-activation of an Scell, base station 10 inticates, to terminal 20, an index value that represents an updated PUCCH-cell timing pattern.

By way of example, in FIG. 3, prior to slot #0, base station 10 transmits, to terminal 20, an index value “2” of the pattern (Pcell, Pcell, Pcell, cell 1, Pcell, Pcell) in which cell 2 is not used as a PUCCH cell. In slot #0 and subsequent slots, terminal 20 determines a PUCCH cell based on the updated pattern (Pcell, Pcell, Pcell, cell 1, Pcell, Pcell).

Consequently, terminal 20 transmits the UCI through the Pcell in slots #0, #1, and #2, transmits the UCI through cell 1 in slot #3, and transmits the UCI through the Pcell in slots #4 and #5.

Opt 1-1 has an advantage of being associated with a minor impact on the specifications because pattern switching can be performed from the beginning of a PUCCH-cell timing pattern.

[Opt 1-2]: The semi-static PUCCH-cell timing pattern may be updated by a dynamic indication.

In this case, prior to the timing of de-activation of an Scell, base station 10 inticates, to terminal 20, an index value that representes an updated PUCCH-cell timing pattern.

Opt 1-2 has an advantage of being associated with a flexible update of a PUCCH-cell timing pattern because pattern switching can be performed even in the middle of a PUCCH-cell timing pattern.

Opt 1-2 includes the following variations.

[Opt 1-2A]: A PUCCH-cell timing pattern is updated with indication of a new PUCCH-cell timing pattern to terminal 20.

In this case, terminal 20 performs the PUCCH carrier switching in accordance with the new PUCCH-cell timing pattern upon receiving an index value that representes the new PUCCH-cell timing pattern.

By way of example, in FIG. 3, prior to slot #5, base station 10 transmits, to terminal 20, an index value “2” of the pattern (Pcell, Pcell, Pcell, cell 1, Pcell, Pcell) in which cell 2 is not used as a PUCCH cell. Terminal 20 determines, starting from slot #5, a PUCCH cell based on the updated pattern (Pcell, Pcell, Pcell, cell 1, Pcell, Pcell).

Consequently, terminal 20 transmits the UCI through the Pcell in slots #0, #1, and #2, transmits the UCI through cell 1 in slot #3, transmits the UCI through cell 2 in slot #4, and transmits the UCI through the Pcell in slot #5.

[Opt 1-2B]: A PUCCH-cell timing pattern is updated by replacing an Scell to be de-activated with an another activated cell. Incidentally, as an exemplary indication method of cell replacement, the following alternations may be included.

[Alt 1]: Index value #i representing an Scell to be de-activated and index value #j representing a cell for replacement are indicated to terminal 20.

For example, in FIG. 3, supposing that the cell for replacement is cell 1, base station 10 indicates, to terminal 20, index value #i representing cell 2 to be de-activated and index value #j representing cell 1 for replacement. Terminal 20 determines, starting from slot #5, a PUCCH cell based on a pattern, which is obtained by replacing cell 2 in an enabled pattern (Pcell, Pcell, Pcell, cell 1, cell 2, cell 2) with cell 1, i.e., the pattern (Pcell, Pcell, Pcell, cell 1, cell 1, cell 1). Consequently, terminal 20 transmits the UCI through the Pcell in slots #0, #1, and #2, transmits the UCI through cell 1 in slot #3, transmits the UCI through cell 2 in slot #4, and transmits the UCI through cell 1 in slot #5.

[Alt 2]: A cell for replacement is fixed by default (e.g., Pcell), and only index value #i representing an Scell to be de-activated is indicated to terminal 20.

For example, in FIG. 3, supposing that the cell for replacement is configured to the Pcell in advance. In this case, base station 10 indicates, to terminal 20, index value #i representing cell 2 to be de-activated. Terminal 20 determines, starting from slot #5, a PUCCH cell based on a pattern, which is obtained by replacing cell 2 in an enabled pattern (Pcell, Pcell, Pcell, cell 1, cell 2, cell 2) with the Pcell, i.e., the pattern (Pcell, Pcell, Pcell, cell 1, Pcell, Pcell).

Consequently, terminal 20 transmits the UCI through the Pcell in slots #0, #1, and #2, transmits the UCI through cell 1 in slot #3, transmits the UCI through cell 2 in slot #4, and transmits the UCI through the Pcell in slot #5.

Incidentally, in Opt 1-2, the dynamic indication may be given to terminal 20 by the DCI, or may be given to terminal 20 by Medium Access Control Control Element (MAC CE). This allows the implementation of base station 10 to ensure that PUCCH cells in the current PUCCH-cell timing pattern are not de-activated.

When the dynamic indication is given by the DCI, a DCI format may be either a new DCI format or an existing DCI format with a new or existing unused field (e.g., FDRA field).

When the unused field of the existing DCI format is re-interpreted for an update of a PUCCH-cell timing pattern, terminal 20 may use some specific DCI fields so as to determine whether the received DCI should be interpreted for the purpose of the pattern update or should be interpreted for other purposes. In one example, when all fields such as HARQ Process, TDRA, SRI, TPMI, and the like are “0,” an FDRA field is re-interpreted for purpose of the pattern update.

Further, when the dynamic indication is given by the DCI, the DCI indicates mapping for the cell replacement in the case of Opt 1-2B and indicates a new PUCCH-cell timing pattern in the case of Opt 1-2A.

Meanwhile, when the dynamic indication is given by the MAC CE, a new MAC CE may be introduced. Alternatively, the dynamic indication may be displayed along with displaying of Scell activation/de-activation, with enhancment on the basis of an Scell activation/de-activation MAC CE.

### Option 2

In Option 2, a rule is defined for a case where any Scell in a PUCCH-cell timing pattern may be de-activated, and terminal 20 executes control according to the rule.

In Option 2, information indicating a timing of the Scell activation/deactivation is indicated to terminal 20. Indication of the information may be performed by physical layer signaling (e.g., DCI), higher layer signaling (e.g., RRC signaling, MAC signaling, broadcast information (Master Information Block (MIB), System Information Block (SIB))), and other signals, or a combination thereof.

In the following, variations of Option 2 (Opt 2) and the details of each variation will be specifically described.

[Opt 2-1]: When any Scell in a PUCCH-cell timing pattern is de-activated, the semi-static PUCCH carrier switching is disabled by terminal 20 based on the rule.

After the semi-static PUCCH carrier switching is disabled, the semi-static PUCCH carrier switching may be enabled again with the Scell activation as a trigger. That is, the semi-static PUCCH carrier switching is enabled when a de-activated cell in a configured PUCCH-cell timing pattern is activated again.

Note that it is required that the semi-static PUCCH carrier switching is enabled by explicit signaling.

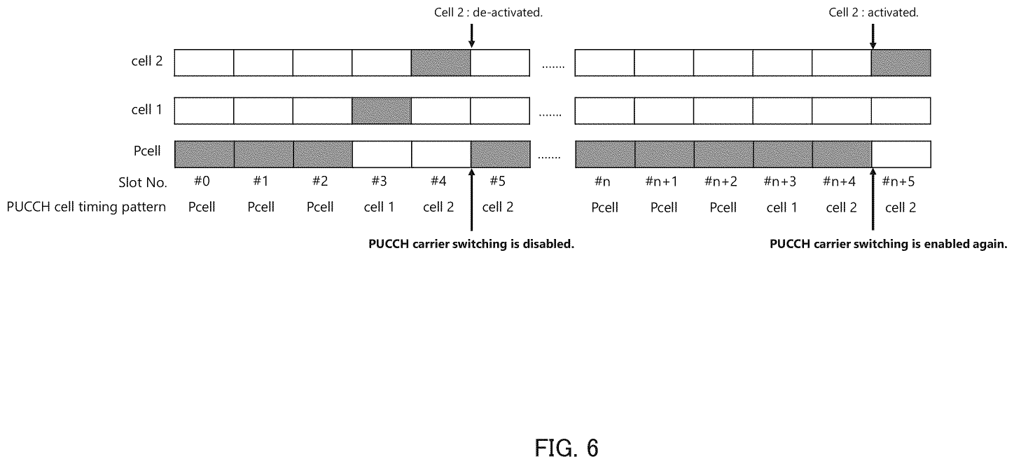

A concrete example of Opt 2-1 will be described with reference to FIG. 6. In the example of FIG. 6, it is assumed that a Pcell and two Scells (cell 1 and cell 2) are candidate PUCCH cells. Further, in the example of FIG. 6, it is assumed that an enabled PUCCH-cell timing pattern is (Pcell, Pcell, Pcell, cell 1, cell 2, cell 2). Moreover, in the example of FIG. 6, it is assumed that cell 2 is determined to be de-activated from slot #5 and to be activated again from slot #n+4.

In this case, in slots #0 to #4 where cell 2 is activated, terminal 20 determines a PUCCH pattern in accordance with the enabled pattern (Pcell, Pcell, Pcell, cell 1, cell 2, cell 2). Consequently, terminal 20 transmits the UCI through the Pcell in slots #0, #1, and #2, transmits the UCI through cell 1 in slot #3, and transmits the UCI through cell 2 in slot #4.

On the other hand, in slots #5 to #n+4 where cell 2 is de-activated, terminal 20 disables the PUCCH carrier switching and always determines the Pcell as a PUCCH cell. Consequently, terminal 20 transmits the UCI through the Pcell in slots #5 to #n+4.

Additionally, in slot #n+5 and subsequent slots where cell 2 is activated again, terminal 20 determines a PUCCH cell in accordance with the enabled pattern (Pcell, Pcell, Pcell, cell 1, cell 2, cell 2).

[Opt 2-2]: When any Scell in a PUCCH-cell timing pattern is de-activated, the PUCCH-cell timing pattern is updated by terminal 20 based on the rule.

Opt 2-2 includes the following variations.

[Opt 2-2A]: Terminal 20 enables another PUCCH-cell timing pattern that includes only activated cells.

The plurality of PUCCH-cell timing patterns that has been configured in advance is ordered in sequence, and terminal 20 selects, from the patterns including only activated cells, the one having the highest order.

In a case where a pattern including only activated cells is not configured, the semi-static PUCCH carrier switching is disabled until the following alternatives occur.

[Alt.1]: A de-activated cell is activated again by explicit signaling.

[Alt.2]: A cell de-activated in a previously applied PUCCH-cell timing pattern is activated.

[Alt.3]: Any available PUCCH cell pattern, i.e., a pattern including only activated cells becomes available.

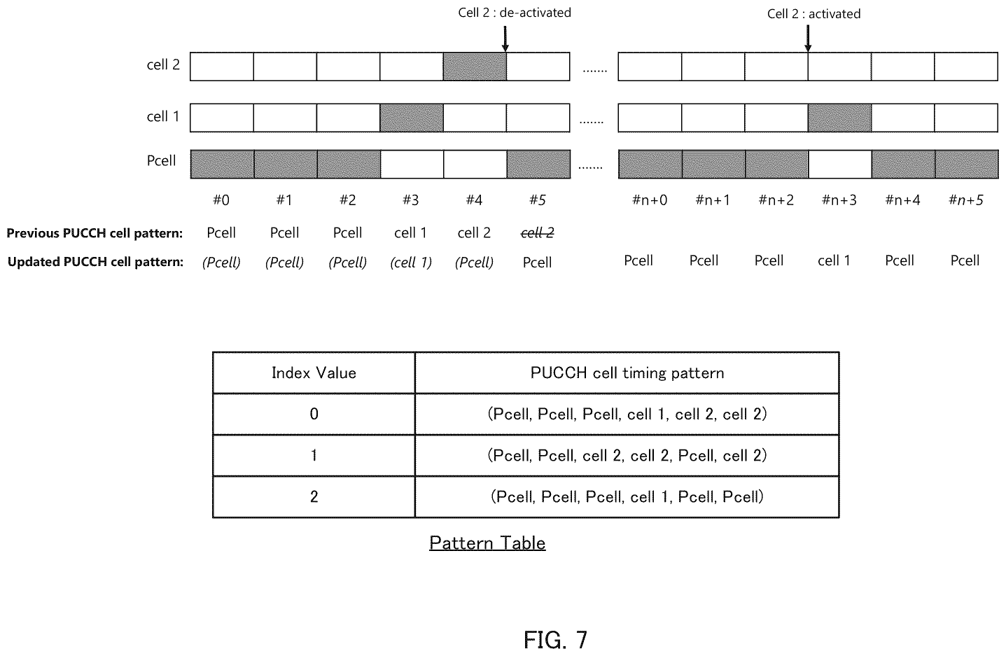

A concrete example of Opt 2-2A will be described with reference to FIG. 7. In the example of FIG. 7, it is assumed that a Pcell and two Scells (cell 1 and cell 2) are candidate PUCCH cells. Further, in the example of FIG. 7, it is assumed that an enabled PUCCH-cell timing pattern until cell 2 is de-activated is (Pcell, Pcell, Pcell, cell 1, cell 2, cell 2). Moreover, in the example of FIG. 7, it is assumed that cell 2 is determined to be de-activated from slot #5 and to be activated again from slot #n+3.

In this case, in slots #0 to #4 where cell 2 is activated, terminal 20 determines a PUCCH pattern in accordance with the enabled pattern (Pcell, Pcell, Pcell, cell 1, cell 2, cell 2). Consequently, terminal 20 transmits the UCI through the Pcell in slots #0, #1, and #2, transmits the UCI through cell 1 in slot #3, and transmits the UCI through cell 2 in slot #4.

Besides, in slot #5 and subsequent slots where cell 2 is de-activated, terminal 20 disables the PUCCH carrier switching before slot #5 and determines a PUCCH cell in accordance with a new pattern (Pcell, Pcell, Pcell, cell 1, Pcell, Pcell) including only the activated cells (Pcell and cell 1). In addition, terminal 20 transmits an index value “2” of the new pattern to base station 10.

Consequently, terminal 20 transmits the UCI through the Pcell in slot #5. In addition, terminal 20 transmits the UCI through the Pcell in slots #n+0, #n+1, and #n+2, transmits the UCI through cell 1 in slot #n+3, and transmits the UCI through the Pcell in slot #n+4 and #n+5.

Note that, although cell 2 is activated again at the timing of slot #n+3, terminal 20 performs no pattern change even in slot #n+3 and subsequent slots.

[Opt 2-2B]: A PUCCH-cell timing pattern is updated by terminal 20 replacing an Scell to be de-activated with an another activated cell.

A cell for replacement may be determined by any of the following rules.

[Alt 1]: A cell for replacement is fixed by default (e.g., Pcell).

[Alt2]: When a candidate PUCCH cell set is present, an activated cell in the candidate PUCCH cell set is selected according to the rule.

Note that the candidate PUCCH cell set may be any of the following.

[Alt 2-1]: The Candidate PUCCH cell set is configrued by RRC. In one example, a cell set, which is for PUCCH cell selection when a PUCCH cell is de-activated, is configured.

[Alt 2-2]: The candidate PUCCH cell set is a set of activated cells having a PUCCH resource configuration as well as a set of cells satisfying conditions such as whether or not the cells have the same band as the current de-activated cell and/or whether or not the cells have the same SCS.

In Alt 2, a cell for replacement may be selected from the candidate PUCCH cell set based on a cell index, SCS, a carrier frequency, a DL/UL resource ratio, a bandwidth, and the like

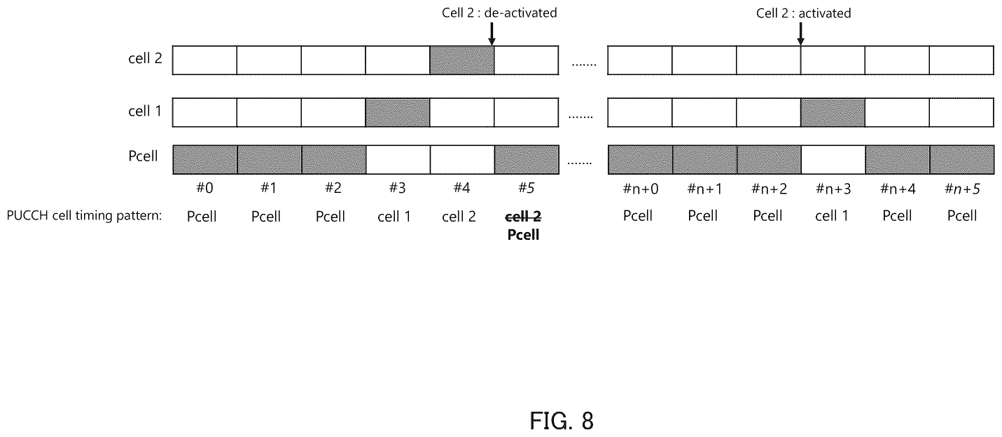

A concrete example of Opt 2-2B will be described with reference to FIG. 8. In the example of FIG. 8, it is assumed that a Pcell and two Scells (cell 1 and cell 2) are candidate PUCCH cells. Further, in the example of FIG. 8, it is assumed that an enabled PUCCH-cell timing pattern until cell 2 is de-activated is (Pcell, Pcell, Pcell, cell 1, cell 2, cell 2). Moreover, in the example of FIG. 8, it is assumed that cell 2 is determined to be de-activated from slot #5 and to be activated again from slot #n+3.

In this case, in slots #0 to #4 where cell 2 is activated, terminal 20 determines a PUCCH pattern in accordance with the enabled pattern (Pcell, Pcell, Pcell, cell 1, cell 2, cell 2). Consequently, terminal 20 transmits the UCI through the Pcell in slots #0, #1, and #2, transmits the UCI through cell 1 in slot #3, and transmits the UCI through cell 2 in slot #4.

Besides, in slot #5 and subsequent slots where cell 2 is de-activated, terminal 20 disables the PUCCH carrier switching before slot #5 and determines a PUCCH cell based on a pattern, which is obtained by replacing cell 2 in an enabled pattern (Pcell, Pcell, Pcell, cell 1, cell 2, cell 2) with the Pcell, i.c., the pattern (Pcell, Pcell, Pcell, cell 1, Pcell, Pcell). Incidentaly, when a cell for replacement is not fixed, terminal 20 transmits, to base station 10, an index value (#i) representing the cell for replacement.

Consequently, terminal 20 transmits the UCI through the Pcell in slot #5. In addition, terminal 20 transmits the UCI through the Pcell in slots #n+0, #n+1, and #n+2, transmits the UCI through cell 1 in slot #n+3, and transmits the UCI through the Pcell in slot #n+4 and #n+5.

Note that, although cell 2 is activated again at the timing of slot #n+3, terminal 20 performs no pattern change even in slot #n+3 and subsequent slots.

[Opt 2-3]: When any Scell in a PUCCH-cell timing pattern is de-activated, a PUCCH cell change pattern is temporarily modified by terminal 20 based on the rule.

Note that, unlike Opt 2-2, a PUCCH-cell timing pattern is not updated in Opt 2-3. That is, in Opt 2-3, a PUCCH timing pattern continues to be used when a de-activated Scell(s) in the PUCCH-cell timing pattern is/are activated again.

Opt 2-3 includes the following variations.

[Opt 2-3A]: Terminal 20 temporarily uses another PUCCH-cell timing pattern that includes only activated cells.

Note that a method of determining the other PUCCH-cell timing pattern may be the same as the method of Opt 2-2A described above.

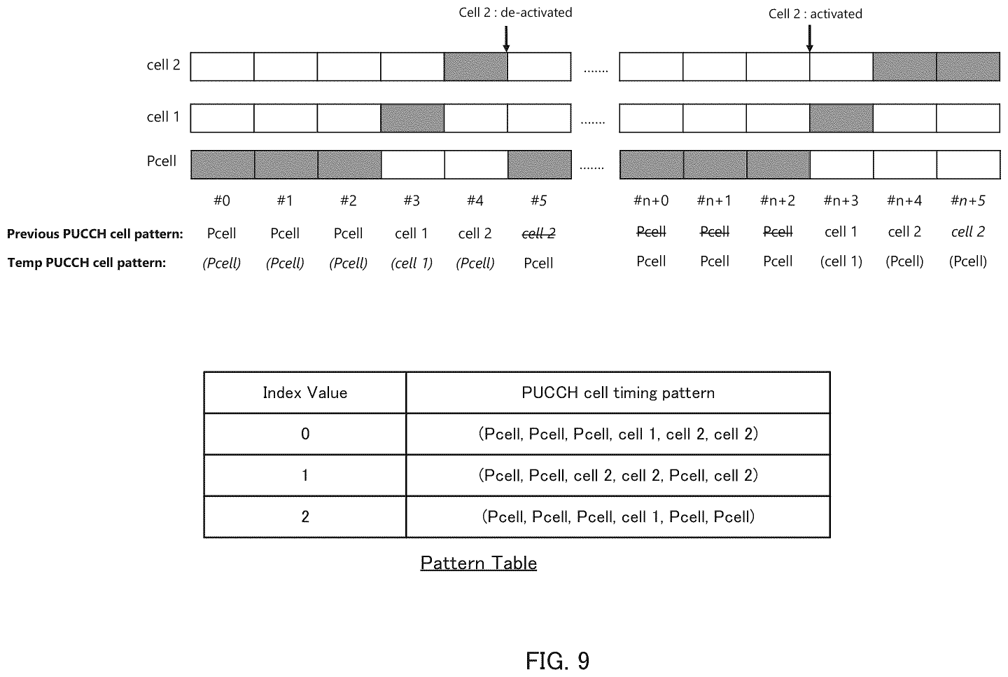

A concrete example of Opt 2-3A will be described with reference to FIG. 9. In the example of FIG. 9, it is assumed that a Pcell and two Scells (cell 1 and cell 2) are candidate PUCCH cells. Further, in the example of FIG. 9, it is assumed that an enabled PUCCH-cell timing pattern until cell 2 is de-activated is (Pcell, Pcell, Pcell, cell 1, cell 2, cell 2). Moreover, in the example of FIG. 9, it is assumed that cell 2 is determined to be de-activated from slot #5 and to be activated again from slot #n+3.

In this case, in slots #0 to #4 where cell 2 is activated, terminal 20 determines a PUCCH pattern in accordance with the enabled pattern (Pcell, Pcell, Pcell, cell 1, cell 2, cell 2). Consequently, terminal 20 transmits the UCI through the Pcell in slots #0, #1, and #2, transmits the UCI through cell 1 in slot #3, and transmits the UCI through cell 2 in slot #4.

Besides, in slot #5 and subsequent slots where cell 2 is de-activated, terminal 20 temporarily disables the PUCCH carrier switching before slot #5 until cell 2 is activated again and determines a PUCCH cell in accordance with a new pattern (Pcell, Pcell, Pcell, cell 1, Pcell, Pcell) including only the activated cells (Pcell and cell 1). In addition, terminal 20 transmits an index value “2” of the new pattern to base station 10.

Consequently, terminal 20 transmits the UCI through the Pcell in slot #5. In addition, terminal 20 transmits the UCI through the Pcell in slots #n+0, #n+1, and #n+2.

Further, since cell 2 is activated again in slot #n+3, terminal 20 determines a PUCCH cell in accordance with the previous pattern (Pcell, Pcell, Pcell, cell 1, cell 2, cell 2). Consequently, terminal 20 transmits the UCI through cell 1 in slot #n+3 and transmits the UCI through cell 2 in slots #n+4 and #n+5.

[Opt 2-3B]: A de-activated Scell is temporarily replaced with another activated cell by terminal 20.

Note that a method of determining the other activated cell for replacement may be the same as the method of Opt 2-2B described above.

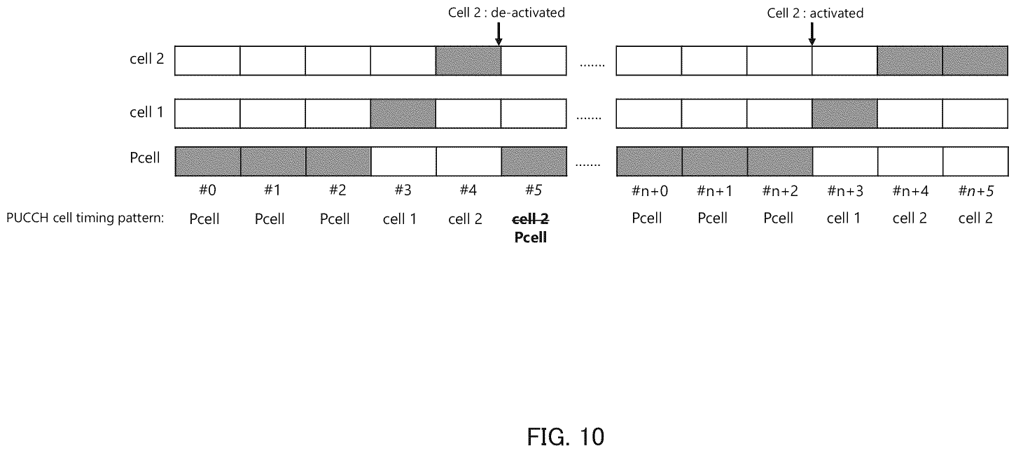

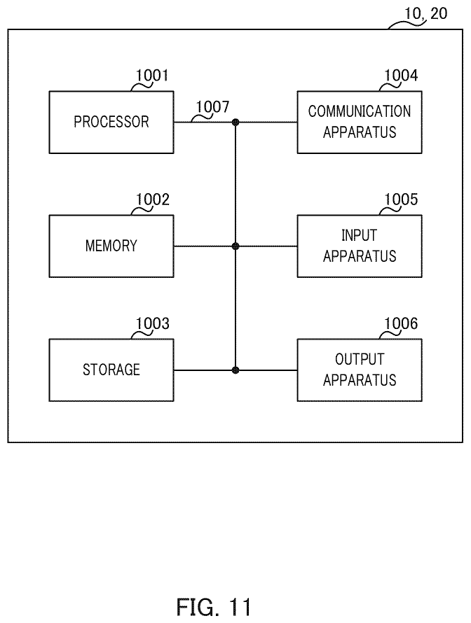

A concrete example of Opt 2-3B will be described with reference to FIG. 10. In the example of FIG. 10, it is assumed that a Pcell and two Scells (cell 1 and cell 2) are candidate PUCCH cells. Further, in the example of FIG. 10, it is assumed that an enabled PUCCH-cell timing pattern until cell 2 is de-activated is (Pcell, Pcell, Pcell, cell 1, cell 2, cell 2). Moreover, in the example of FIG. 10, it is assumed that cell 2 is determined to be de-activated from slot #5 and to be activated again from slot #n+3.

In this case, in slots #0 to #4 where cell 2 is activated, terminal 20 determines a PUCCH pattern in accordance with the enabled pattern (Pcell, Pcell, Pcell, cell 1, cell 2, cell 2). Consequently, terminal 20 transmits the UCI through the Pcell in slots #0, #1, and #2, transmits the UCI through cell 1 in slot #3, and transmits the UCI through cell 2 in slot #4.

Besides, in slot #5 and subsequent slots where cell 2 is de-activated, terminal 20 temporarily disables the PUCCH carrier switching before slot #5 and determines a PUCCH cell based on a pattern, which is obtained by replacing cell 2 in an enabled pattern (Pcell, Pcell, Pcell, cell 1, cell 2, cell 2) with the Pcell, i.e., the pattern (Pcell, Pcell, Pcell, cell 1, Pcell, Pcell). Incidentaly, when a cell for replacement is not fixed, terminal 20 transmits, to base station 10, an index value (#i) representing the cell for replacement.

Consequently, terminal 20 transmits the UCI through the Pcell in slot #5. In addition, terminal 20 transmits the UCI through the Pcell in slots #n+0, #n+1, and #n+2.

Further, since cell 2 is activated again in slot #n+3, terminal 20 determines a PUCCH cell in accordance with the previous pattern (Pcell, Pcell, Pcell, cell 1, cell 2, cell 2). Consequently, terminal 20 transmits the UCI through cell 1 in slot #n+3 and transmits the UCI through cell 2 in slots #n+4 and #n+5.

### Effects

As described above, according to the present embodiment, when performing the semi-static PUCCH carrier switching based on a PUCCH-cell timing pattern, terminal 20 can always configure an activated cell with PUCCH and then transmit the UCI even when an Scell is de-activated.

### Variations

The above description has indicated that, with respect to one configuration, any of a plurality of options is applied and/or any of a plurality of alternatives (e.g., Alt. 1, Alt. 2, and the like hereinabove) is applied. For example, which of the plurality of options is applied, and/or which of the plurality of alternatives is applied may be determined by the following methods:
It is/they are configured by higher-layer parameter,
The UE reports it/them as UE capability(ies);
It is/they are described in the specifications,
It is/they are determined based on configuration of higher-layer parameter and reported UE capability; and
It is/they are determined by a combination of two or more of the above determinations.
   Note that the higher layer parameter may be RRC parameter, Media Access Control Control Element (MAC CE), or may be a combination thereof.

### UE Capability

The UE capability representing the capability of the UE may include the following information indicating the capability of the UE. Note that the information representing the capability of the UE may correspond to information defining the capability of the UE.
Information defining whether the UE supports the PUCCH carrier switching;
Information defining whether the UE supports the semi-static PUCCH carrier switching;
Information defining whether the UE supports the semi-static PUCCH carrier switching based on the Scell enabling/disabling;
Information defining whether the UE supports an update of a PUCCH-cell timing pattern based on a dynamic indication;
Information defining whether the UE supports an update of a PUCCH-cell timing pattern based on a rule for the Scell enabling/disabling; and
Information defining whether the UE supports a temporary PUCCH-cell timing pattern used when any cell in the PUCCH cell timing pattern is de-activated.

### (Hardware Configuration)

Note that, the block diagrams used to describe the embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (for example, via wires or by radio), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmitting unit,” “transmission section,” or “transmitter.” The methods for implementing the functions are not limited specifically as described above.

For example, the base station, the terminal, and the like according to an embodiment

of the present disclosure may function as a computer that executes processing of a wireless communication method of the present disclosure. FIG. 11 illustrates an example of hardware configurations of the base station and the terminal according to an embodiment of the present disclosure. Base station 10 and terminal 20 described above may be each physically constituted as a computer apparatus including processor 1001, memory 1002, storage 1003, communication apparatus 1004, input apparatus 1005, output apparatus 1006, bus 1007, and the like.

Note that, the term “apparatus” in the following description can be replaced with a circuit, a device, a unit, or the like. The hardware configurations of base station 10 and of terminal 20 may include one apparatus or a plurality of apparatuses illustrated in the drawings, or may not include part of the apparatuses.

The functions of base station 10 and terminal 20 are implemented by predetermined software (program) loaded into hardware such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control section 103 and control section 203 as described above may be implemented by processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiment is used. For example, control section 103 of base station 10 or control section 203 of terminal 20 may be implemented by a control program stored in memory 1002 and operated by a control program operating in processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented by one or more chips. Note that, the program may be transmitted from a network through a telecommunication line.

Memory 1002 is a computer-readable recording medium and may be composed of, for example, at least one of a ROM (Read Only Memory), an EPROM (Erasable Programmable ROM), an EEPROM (Electrically Erasable Programmable ROM), and a RAM (Random Access Memory). Memory 1002 may be called a register, a cache, a main memory (main storage apparatus), or the like. Memory 1002 can save a program (program code), a software module, and the like that can be executed to carry out the wireless communication method according to an embodiment of the present disclosure.

Storage 1003 is a computer-readable recording medium and may be composed of, for example, at least one of an optical disk such as a CD-ROM (Compact Disc ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called an auxiliary storage apparatus. The storage medium as described above may be, for example, a database, a server or other appropriate media including at least one of memory 1002 and storage 1003.

Communication apparatus 1004 is hardware (transmission and reception device) for communication between computers through at least one of wired and wireless networks and is also called, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, transmission section 101, reception section 102, reception section 201, and transmission section 202, and the like as described above may be realized by communication apparatus 1004.

Input apparatus 1005 is an input device (for example, a keyboard, a mouse, a microphone, a switch, a button, or a sensor) that receives input from the outside. Output apparatus 1006 is an output device (for example, a display, a speaker, or an LED lamp) which makes outputs to the outside. Note that, input apparatus 1005 and output apparatus 1006 may be integrated (for example, a touch panel).

The apparatuses, such as processor 1001, memory 1002 and the like, are connected by bus 1007 for communication of information. Bus 1007 may be configured using one bus or using buses different between each pair of the apparatuses.

Furthermore, base station 10 and terminal 20 may include hardware, such as a microprocessor, a digital signal processor (DSP), an ASIC (Application Specific Integrated Circuit), a PLD (Programmable Logic Device), and an FPGA (Field Programmable Gate Array), and the hardware may implement part or all of the functional blocks. For example, processor 1001 may be implemented using at least one of these pieces of hardware.

### (Notification and Signaling of Information)

The notification of information is not limited to the aspect/embodiment described in the present disclosure, and the information may be notified by another method. For example, the notification of information may be carried out by one or a combination of physical layer signaling (for example, Downlink Control Information (DCI) and Uplink Control Information (UCI)), higher layer signaling (for example, Radio Resource Control (RRC) signaling, Medium Access Control (MAC) signaling, broadcast information (Master Information Block (MIB), and System Information Block (SIB))), and other signals or a combination thereof. The RRC signaling may be called an RRC message and may be, for example, an RRC connection setup message, an RRC connection reconfiguration message, or the like.

### (Applied System)

The aspect/embodiment described in the present specification may be applied to at least one of systems using Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least LTE or LTE-A and 5G) may be applied.

(Processing Procedure and/or the like)

The orders of the processing procedures, the sequences, the flowcharts, and the like of the aspect/embodiment described in the present disclosure may be changed as long as there is no contradiction. For example, elements of various steps are presented in exemplary orders in the methods described in the present disclosure, and the methods are not limited to the presented specific orders.

### (Operation of Base Station)

Specific operations which are described in the present disclosure as being performed by the base station may sometimes be performed by an upper node depending on the situation. Various operations performed for communication with a terminal in a network constituted by one network node or a plurality of network nodes including a base station can be obviously performed by at least one of the base station and a network node other than the base station (examples include, but not limited to, Mobility Management Entity (MME) or Serving Gateway (S-GW)). Although there is one network node in addition to the base station in the case illustrated above, a plurality of other network nodes may be combined (for example, MME and S-GW).

### (Direction of Input and Output)

The information or the like (*see the item of “Information and Signals”) can be output from a higher layer (or lower layer) to a lower layer (or higher layer). The information and the like may be input and output through a plurality of network nodes.

(Handling of Input and Output Information and the like)

The input and output information and the like may be saved in a specific place (for example, memory) or may be managed using a management table. The input and output information and the like can be overwritten, updated, or additionally written. The output information and the like may be deleted. The input information and the like may be transmitted to another apparatus.

### (Determination Method)

The determination may be made based on a value expressed by one bit (0 or 1), based on a Boolean value (true or false), or based on comparison with a numerical value (for example, comparison with a predetermined value).

### (Software)

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., coaxial cable, optical fiber cable, twisted pair, and digital subscriber line (DSL)) and a radio technique (e.g., infrared ray and microwave), the at least one of the wired technique and the radio technique is included in the definition of the transmission medium.

### (Information and Signals)

The information, the signals, and the like described in the present disclosure may be expressed by using any of various different techniques. For example, data, instructions, commands, information, signals, bits, symbols, chips, and the like that may be mentioned throughout the entire description may be expressed by one or a random combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

### (“System” and “Network”)

The terms “system” and “network” used in the present disclosure can be interchangeably used.

### (Names of Parameters and Channels)

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulae and the like using the parameters may be different from the ones explicitly disclosed in the present disclosure. Various channels (for example, PUCCH and PDCCH) and information elements, can be identified by any suitable names, and various names assigned to these various channels and information elements are not limitative in any respect.

### (Base Station (Radio Base Station))

The terms “Base Station (BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” and “component carrier” may be used interchangeably in the present disclosure. The base station may be called a macro cell, a small cell, a femtocell, or a pico cell.

The base station can accommodate one cell or a plurality of (for example, three)

cells. When the base station accommodates a plurality of cells, the entire coverage area of the base station can be divided into a plurality of smaller areas, and each of the smaller areas can provide a communication service based on a base station subsystem (for example, small base station for indoor remote radio head (RRH)). The term “cell” or “sector” denotes part or all of the coverage area of at least one of the base station and the base station subsystem that perform the communication service in the coverage.

### (Terminal)

The terms “Mobile Station (MS),” “user terminal,” “User Equipment (UE),” and “terminal” may be used interchangeably in the present disclosure.

The mobile station may be called, by those skilled in the art, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user agent, a mobile client, a client, or by some other appropriate terms.

### (Base Station/Mobile Station)

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a means of transport (e.g., automobile, airplane, or the like), an unmanned mobile entity (e.g., drone, autonomous driving vehicle, or the like), or a robot (manned or unmanned). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the user terminal. For example, the aspect/embodiment of the present disclosure may find application in a configuration that results from replacing communication between the base station and the user terminal with communication between multiple user terminals (such communication may, for example, be referred to as device-to-device (D2D), vehicle-to-everything (V2X), or the like). In this case, terminal 20 may be configured to have the functions that base station 10 described above has. The wordings “uplink” and “downlink” may be replaced with a corresponding wording for inter-terminal communication (for example, “side”). For example, an uplink channel, a downlink channel, and the like may be replaced with a side channel.

Similarly, the terminal in the present disclosure may be replaced with the base station. In this case, base station 10 is configured to have the functions that terminal 20 described above has.

### (Meaning and Interpretation of Terms)

As used herein, the term “determining” may encompass a wide variety of actions. For example, “determining” may be regarded as judging, calculating, computing, processing, deriving, investigating, looking up (search or inquiry) (e.g., looking up in table, database or another data structure), ascertaining and the like. Furthermore, “determining” may be regarded as receiving (for example, receiving information), transmitting (for example, transmitting information), inputting, outputting, accessing (for example, accessing data in memory) and the like. Further, “determining” may be regarded as resolving, selecting, choosing, establishing, comparing and the like. That is, “determining” may be regarded as a certain type of action related to determining. Further, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

### (Reference Signal)

The reference signal can also be abbreviated as an RS and may also be called as a pilot depending on the applied standard.

(Meaning of “Based on”)

The description “based on” used in the present disclosure does not mean “based only on,” unless otherwise specified. In other words, the description “based on” means both of “based only on” and “based at least on.”

### (Terms “First” and “Second”)

Any reference to elements by using the terms “first,” “second,” and the like that are used in the present disclosure does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

### (“Means”)

The “section” in the configuration of each apparatus described above may be replaced with “means,” “circuit,” “device,” or the like.

### (Open-Ended Format)

In a case where terms “include,” “including,” and their modifications are used in the present disclosure, these terms are intended to be inclusive like the term “comprising.” Further, the term “or” used in the present disclosure is not intended to be an exclusive or.

(Time Units such as a TTI, Frequency Units such as an RB, and a Radio Frame Configuration)

The radio frame may be constituted by one frame or a plurality of frames in the time domain. The one frame or each of the plurality of frames may be called a subframe in the time domain. The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be

constituted by one or more symbols in the time domain. Furthermore, the mini-slot may be referred to as a subslot. The mini-slot may be constituted by a smaller number of symbols than that of the slot. PDSCH (or PUSCH) that is transmitted in the time unit that is greater than the mini-slot may be referred to as PDSCH (or PUSCH) mapping type A. PDSCH (or PUSCH) that is transmitted using the mini-slot may be referred to as PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (for example, 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (frequency bandwidth, transmit power, and the like that are used in each user terminal) on a TTI-by-TTI basis to each user terminal. Note that the definition of TTI is not limited to this.

The TTI may be a time unit for transmitting a channel-coded data packet (transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or

more TTIs (that is, one or more slots, or one or more mini-slots) may be a minimum time unit for the scheduling. Furthermore, the number of slots (the number of mini-slots) that makes up the minimum time unit for the scheduling may be controlled.

A TTI that has a time length of 1 ms may be referred to as a usual TTI (TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini-slot, a subslot, a slot, or the like.

Note that the long TTI (for example, usual TTI, subframe, or the like) may be replaced with the TTI that has a time length which exceeds 1 ms, and the short TTI (for example, shortened TTI or the like) may be replaced with a TTI that has a TTI length which is less than a TTI length of the long TTI and is equal to or longer than 1 ms.

A resource block (RB) is a resource-allocation unit in the time domain and the frequency domain, and may include one or more contiguous subcarriers in the frequency domain. The number of subcarriers that is included in the RB may be identical regardless of the numerology, and may be 12, for example. The number of subcarriers that is included in the RB may be determined based on the numerology.

In addition, the RB may include one symbol or a plurality of symbols in the time domain, and may have a length of one slot, one mini slot, one subframe, or one TTI. One TTI, one subframe, and the like may be each constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as partial bandwidth or the like) may represent a subset of contiguous common resource blocks (RB) for certain numerology in a certain carrier. Here, the common RBs may be identified by RB indices with reference to a common reference point of the carrier. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that, “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that is included in the radio frame, the number of slots per subframe or radio frame, the number of mini-slots that is included within the slot, the numbers of symbols and RBs that are included in the slot or the mini-slot, the number of subcarriers that is included in the RB, the number of symbols within the TTI, the symbol length, the Cyclic Prefix (CP) length, and the like can be changed in various ways.

In a case where articles, such as “a,” “an,” and “the” in English, for example, are added in the present disclosure by translation, nouns following these articles may have the same meaning as used in the plural.

In the present disclosure, the expression “A and B are different” may mean that “A and B are different from each other.” Note that, the expression may also mean that “A and B are different from C.” The expressions “separated” and “coupled” may also be interpreted in the same manner as the expression “A and B are different.”

### (Variations and the Like of Aspects)

The aspect/embodiment described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiment described in the present disclosure. Modifications and variations of the aspect of the present disclosure can be made without departing from the spirit and the scope of the present disclosure defined by the description of the appended claims. Therefore, the description of the present disclosure is intended for exemplary description and does not limit the present disclosure in any sense.

### INDUSTRIAL APPLICABILITY

An aspect of the present disclosure is useful for mobile communication systems.

### REFERENCE SIGNS LIST

10 Base station
20 Terminal
101, 202 Transmission section
102, 201 Reception section
103, 203 Control section

1.-6. (canceled)

7. A terminal comprising:
a control section that performs semi-static control information cell switching based on a switching pattern of a cell for transmitting control information; and
a transmission section that transmits the control information in the cell,
wherein the control information cell switching is disabled when any SCell is deactivated.

8. The terminal according to claim 7, wherein
the switching pattern is notified by an upper layer parameter, and
the control information cell switching is disabled when the switching pattern is not set.

9. A wireless communication method, comprising:
performing semi-static control information cell switching based on a switching pattern of a cell for transmitting control information; and
transmitting the control information in the cell,
wherein the control information cell switching is disabled when any SCell is deactivated.

10. The wireless communication method according to claim 9, wherein
the switching pattern is notified by an upper layer parameter, and
the control information cell switching is disabled when the switching pattern is not set.

11. A system including a terminal and a base station, wherein:
the terminal performs semi-static control information cell switching based on a switching pattern of a cell for transmitting control information, and transmits the control information in the cell; and
the base station receives the control information from the terminal in the cell,
wherein the control information cell switching is disabled when any SCell is deactivated.
